(19) United States
(12) Patent Application Publication
(10) Pub. No.: US 2016/0269957 A1
(43) Pub. Date: Sep. 15, 2016

(54) METHOD FOR SELECTING NETWORK AND ELECTRONIC DEVICE THEREFOR

(71) Applicants: SAMSUNG ELECTRONICS CO., LTD., Suwon-si, Gyeonggi-do (KR); KOREA UNIVERSITY RESEARCH AND BUSINESS FOUNDATION, Seoul (KR)

(72) Inventors: Chi-Hong CHO, Suwon-si (KR); Hwang-Nam KIM, Seoul (KR); Kang-Ho KIM, Busan (KR); Hwan-Tae KIM, Seoul (KR); Mun-Gyu BAE, Pohang-si (KR); Suk-Kyu LEE, Seoul (KR)

(73) Assignee: Korea University Research And Business Foundation, Seoul (KR)

(21) Appl. No.: 15/030,771

(22) PCT Filed: Sep. 15, 2014
(86) PCT No.: PCT/KR2014/008550

§ 371 Date: Apr. 20, 2016

(30) Foreign Application Priority Data
Oct. 21, 2013 (KR) 10-2013-0125136

(51) Int. Cl. H04W 36/14; H04W 36/00; H04W 4/00; H04W 36/24

(52) U.S. Cl. CPC H04W 36/14; H04W 36/24; H04W 36/0022; H04W 4/008; H04W 4/005

(57) ABSTRACT

The present disclosure relates to change a network adaptively for an electronic device. According to various embodiments, the electronic device may comprise performing data communication with at least one electronic device over a first communication network, detecting a change associated with a state of network based on at least one of a link connection state with the at least one electronic device and a feature of an application executed in the electronic device, and performing data communication with the at least one electronic device over a second communication network. The electronic device can configure the network according to a state of overall network and control/manage elements of the overall network.

### BACKGROUND OF THE INVENTION

The present disclosure relates generally to an electronic device. More particularly, the present disclosure relates to a method and an apparatus for selectively using Z-wave and Wireless Fidelity (WiFi) networks.

As researches are actively conducted on a smart home, Machine to Machine (M2M) technology and Device to Device (D2) technology are emerging as important issues. In recent, mobile phone subscribers approach saturation and a new item is demanded. Hence, mobile telecommunication providers turn their attention to the M2M technology which is a communication technology between two or more objects without user's direct intervention. By use of the M2M technology, the object can determine a situation without user's intervention and adequately cope with the situation. For example, when the M2M is adopted to a smart phone, the smart phone can determine that the user is returning home and thus operate an air conditioner and lighting by communicating with the air conditioner and the lighting in a house.

As Internet Protocol version 6 (IPv6) is developed and a unique IP can be assigned to each object, the M2M technology is studied more actively. Each object is assigned its unique IP, and can access Internet and transmit and receive data. As Internet of Things (IoT) is enabled, various attempts are conducted to fuse a smart home service with various techniques such as M2M or IoT. A representative technology using the IoT includes a smart home network. However, in the smart home network, it is difficult for a controller to control and manage all of network nodes because power on/off periods of the nodes are different, the nodes are frequently turned on/off, and overall network configuration frequently changes.

Hence, what is needed is a method for recognizing changes of network elements which dynamically change, configuring a network according to an overall network state, and conjunctively controlling and managing all of the network elements.

### SUMMARY OF THE INVENTION

To address the above-discussed deficiencies of the prior art, it is a primary aspect of the present disclosure to provide a method and an apparatus for selectively utilizing Z-wave and Wireless Fidelity (WiFi) networks in an electronic device.

Another aspect of the present disclosure is to provide a method and an apparatus for detecting link disconnection of a communicating network in an electronic device.

Yet another aspect of the present disclosure is to provide a method and an apparatus for, when detecting link disconnection of a first network during communication via the first network, selecting and communicating via a second network in an electronic device.

Still another aspect of the present disclosure is to provide a method and an apparatus for selectively utilizing at least one of Z-wave and WiFi networks by considering an application feature and a network state in an electronic device.

According to one aspect of the present disclosure, a method of an electronic device for adaptively changing a network in a wireless communication system includes performing data communication with at least one electronic device over a first communication network, detecting a change associated with a state of the network based on at least one of a link connection state with the at least one electronic device and a feature of an application executed in the electronic device, and performing data communication with the at least one electronic device over a second communication network.

According to another aspect of the present disclosure, an electronic device for adaptively changing a network in a wireless communication includes a network selection unit configured to detect a change associated with a state of the network based on at least one of a link connection state with at least one electronic device and a feature of an application executed in the electronic device, and a communication unit configured to perform data communication with the at least one electronic device over a first communication network, and when detecting the change, perform data communication with the at least one electronic device over a second communication network.

### BRIEF DESCRIPTION OF THE DRAWINGS

FIG. 1 illustrates a block diagram of an electronic device for selectively using a network according to an embodiment of the present disclosure;

FIG. 2A illustrates data communication via other network when an electronic device hits a bottleneck according to an embodiment of the present disclosure;

FIG. 2B illustrates data communication by selecting a network according to a link connection state in an electronic device according to an embodiment of the present disclosure;

FIG. 3A illustrates a method for, when detecting a network change event, communicating data via the changed network in an electronic device according to an embodiment of the present disclosure;

FIG. 3B illustrates means for, when a network change event is detected, communicating data via the changed network in an electronic device according to an embodiment of the present disclosure;

FIG. 4 illustrates a protocol stack for selectively using Z-wave and Wireless Fidelity (WiFi) networks according to an embodiment of the present disclosure;

FIG. 5 illustrates a method for selectively using a network according to an application type in an electronic device according to an embodiment of the present disclosure;

FIG. 6 illustrates communication paths of a WiFi network using a Z-wave network structure in an electronic device according to an embodiment of the present disclosure;

FIG. 7 illustrates a method for communicating data according to presence or absence of a path to a destination in an electronic device according to an embodiment of the present disclosure; and

FIG. 8 illustrates a method for recovering link disconnection when the link disconnection is detected in an electronic device according to an embodiment of the present disclosure.

### DETAILED DESCRIPTION OF THE INVENTION

It will now be described with reference to the accompanying drawings, preferred embodiments of the present invention. And, in the following description of the present invention, descriptions of well-known functions and constructions may be omitted for clarity and conciseness. Also, terms described below are terms defined in consideration of the functions of the present invention. The terms vary according to a custom or intention of an operator. Therefore, the definition should be made based on throughout the present specification.

Exemplary embodiments of the present disclosure provide a technique for selectively utilizing different short-range wireless communication networks in an electronic device. Hereinafter, Z-wave and Wireless Fidelity (WiFi) of short-range wireless communication networks are selectively used to ease the understanding, the embodiments of the present disclosure can be equally applied to other short-range wireless communication technologies.

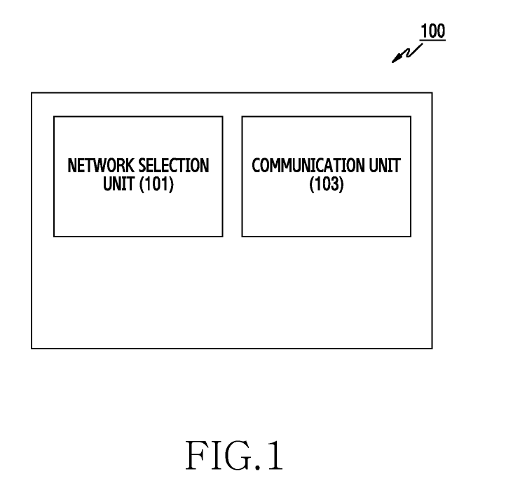

FIG. 1 is a block diagram of an electronic device for selectively using a network according to an embodiment of the present disclosure.

Referring to FIG. 1, an electronic device 100 can include a network selection unit 101 and a communication unit 103.

The network selection unit 101 can select at least one of Z-wave and WiFi, and transmit and receive data via the selected network. In so doing, the networks are not limited to Z-wave and WiFi, and can include other short-range wireless communication networks than Z-wave and WiFi.

First, the network selection unit 101 can determine whether to provide Quality of Service (QoS) based on information of an executed application, and select the network according to whether to provide the QoS. More specifically, the network selection unit 101 can identify a kind (or type) of the executed application based on a predefined ‘Application Command Class’ value of the communicating network, and determine a network for transmitting and receiving data of the corresponding application according to the identified application type. For example, the network selection unit 101 can determine based on the predefined ‘Application Command Class’ value of the Z-wave network, which one of a control application, a reporting application, and a multimedia application is the executed application, and determine a network for transmitting and receiving data of the corresponding application according to the identified application kind (or type). When the executed application is an application requiring a higher bandwidth than a threshold bandwidth like a multimedia application, the network selection unit 101 can transmit and receive data via the WiFi network. By contrast, when the executed application is an application requiring a lower bandwidth than the threshold bandwidth like a control application and a reporting application, the network selection unit 101 can transmit and receive data via the Z-wave or WiFi network based on a network state. In so doing, the network selection unit 101 can determine the network state based on a length of a packet to transmit, the number of packets to transmit (or the number of queued packets), the number of transmitted packets, the number of packets receiving an Acknowledgement (ACK) among the transmitted packets, and the number of nodes currently enabling WiFi with respect to the corresponding application, and determine whether to utilize Z-wave or WiFi for the corresponding application according to a determination result.

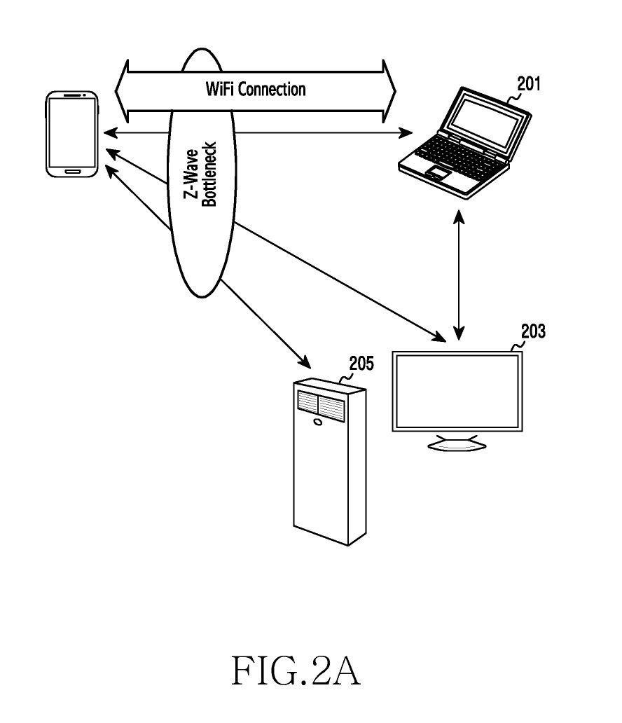

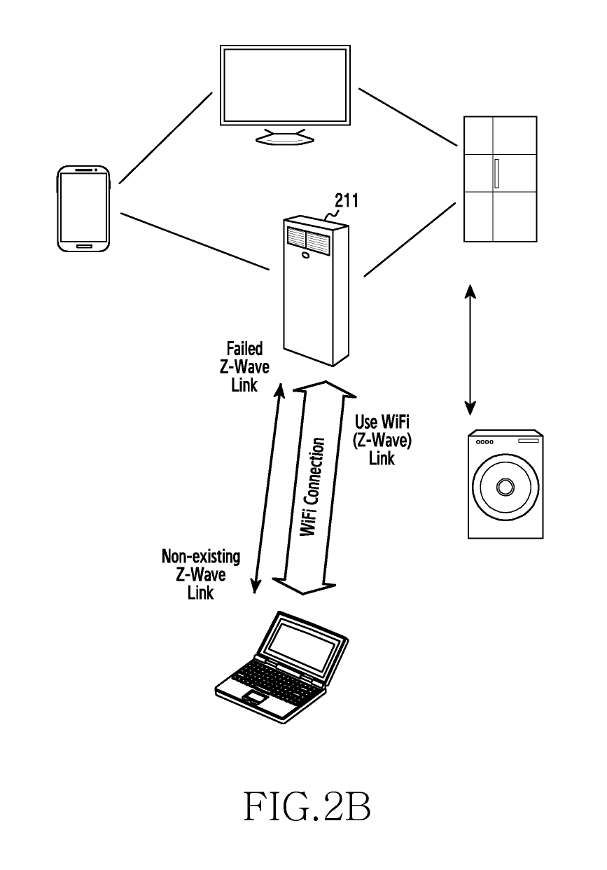

FIG. 2A illustrates data communication via other network when an electronic device hits a bottleneck according to an embodiment of the present disclosure.

Referring to FIG. 2A, the network selection unit 101 can communicate with a first electronic device 201, a second electronic device 203, and a third electronic device 205 over the Z-wave network. For example, as a result of the network state determination, when the number of transmit packets and receive packets via Z-wave rapidly increases during communication with the first electronic device 201, the second electronic device 203, and the third electronic device 205 over the Z-wave network and the electronic device 100 hits or expects a bottleneck as shown in FIG. 2A, the network selection unit 101 can control to communicate data with the first electronic device 201 via the WiFi network and to communicate data with the second electronic device 203 and the third electronic device 205 through Z-wave according to the application type communicating with the electronic devices 201, 202, and 203, a priority which is preset, a packet size, or user control and/or the network state.

Further, the network selection unit 101 turns off the WiFi network and determines whether data communication using the Z-wave network is required. Every time the data communication is required, the WiFi network is turned on and thus network power efficiency can be improved. To turn on WiFi of other electronic device (or other node) and/or an intermediate node to communicate via the WiFi network, the network selection unit 101 can request the other electronic device and/or the intermediate node to turn on WiFi. Herein, the intermediate node indicates a node which is interposed between the electronic device 100 and the other electronic device and delivers the transmit/receive data of the electronic device 100 and the other electronic device. The network selection unit 101 can dynamically operate the WiFi network using ‘Network Connection Graph’ showing nodes connected over the Z-wave network and their connections. The network selection unit 101 can select an intermediate node for delivering data via the WiFi network in ‘Network Connection Graph’, and determine a plurality of independent paths for delivering data via the intermediate node. Herein, the plurality of the independent paths is determined because connectivity of Z-wave does not guarantee connectivity of the WiFi network. Hence, the network selection unit 101 determines the plurality of the independent paths in advance for the WiFi network. When a particular one of the pre-determined independent paths fails the data transmission, the data can be transmitted and received through another path.

FIG. 2B illustrates data communication by selecting a network according to a link connection state in an electronic device according to an embodiment of the present disclosure.

Referring to FIG. 2B, the network selection unit 101 can detect link disconnection of the communicating network. When detecting the link disconnection, the network selection unit 101 can select a different network from the communicating network. More specifically, when detecting link transmission failure or link disconnection due to movement of a node communicating via the Z-wave network or a physical obstacle between the electronic device 100 and the node, the network selection unit 101 can select the WiFi network and conduct the communication. Also, when there is no path for the WiFi network between the electronic device 100 and the communicating node, the network selection unit 101 can select the Z-wave network and conduct the communication. For example, when the electronic device 100 detects link disconnection during the communication with the first electronic device 211 via the Z-wave network or there is no network path using the Z-wave between the electronic device 100 and the first electronic device 211, the network selection unit 101 can perform the communication over the WiFi network.

The network selection unit 101 can determine whether the link is disconnected using the number of transmission/reception failure detection times. For example, when detecting link transmission failure of the other electronic device, the network selection unit 101 can perform link layer retransmission. When detecting three link layer retransmissions due to the link transmission failure, the network selection unit 101 can determine the link disconnection of the communicating network. In so doing, the number of the link layer retransmission times can be set in a design phase and can change under user control.

When the link is disconnected, the network selection unit 101 can conduct the communication using a link of other network through a link disconnection recovery technique. After a data transmission path to a destination is determined, when link disconnection is detected during the data transmission, the network selection unit 101 can request a corresponding node to perform the communication using a link of other network. Also, when a source electronic device requests to transfer particular data to a destination, the network selection unit 101 can confirm a determined path from the source electronic device to the destination and detect whether the link is disconnected with respect to a next node or destination on the confirmed path. In so doing, upon detecting the link disconnection, the network selection unit 101 can carry out the link disconnection recovery function based on a preset data transmission path of a preferred list of Z-wave.

Further, the network selection unit 101 sends a message requesting network information (Network info Request) to neighboring nodes and/or a node of the detected link disconnection over the Z-wave or WiFi network for the link disconnection recovery. When receiving a message including the network information (Network info Response) in response, the network selection unit 101 can transmit and receive data to and from a node which sends the response message over the network which the corresponding message is received over.

When not receiving a message including the network information from the node of the disconnected link, the network selection unit 101 can send packets to at least one other node sending the response message including the network information so as to send the data from the at least one other node to the destination. For example, when detecting Z-wave link disconnection with a next node along a transmission path of particular data, the network selection unit 101 can send a Network info Request message to the next node and a neighboring node over the WiFi network and/or the Z-wave. In so doing, when receiving a Network Response message from the next node over the WiFi network, the network selection unit 101 can send data to the next node over the WiFi network. By contrast, when receiving no Network Response message from the next node, the network selection unit 101 can perform flooding which sends data to other neighboring nodes sending the Network Response via the Z-wave and/or WiFi network and thus request the data transmission to the destination.

The communication unit 103 can transmit and receive data with at least one node over a short-range wireless communication network. The communication unit 103 according to an embodiment of the present disclosure can transmit and receive data over at least one network of Z-wave and WiFi. More specifically, the communication unit 103 can transmit and receive data to and from at least one node over the network selected by the network selection unit 101. In so doing, Z-wave and WiFi are mere examples of the short-range wireless communication network, and the present disclosure may be fulfilled through other short-range wireless communication than Z-wave and WiFi.

Further, the communication unit 103 can send a message requesting network information to a neighboring node over the Z-wave or WiFi network. Also, the communication unit 103 can receive a message including network information in response to the Network info Request message sent to the neighboring node.

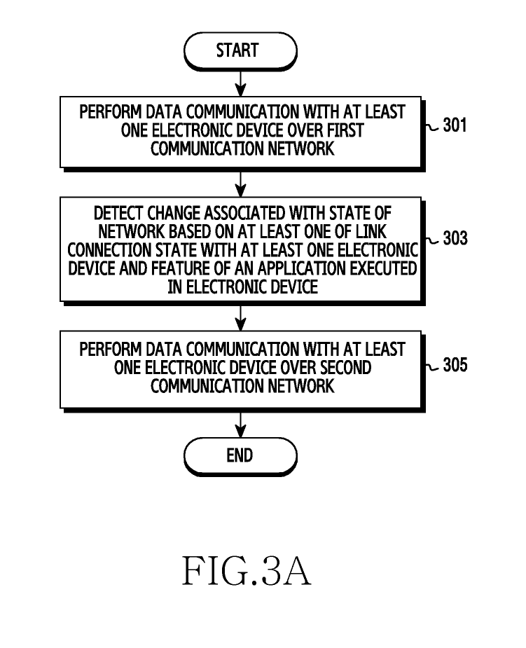

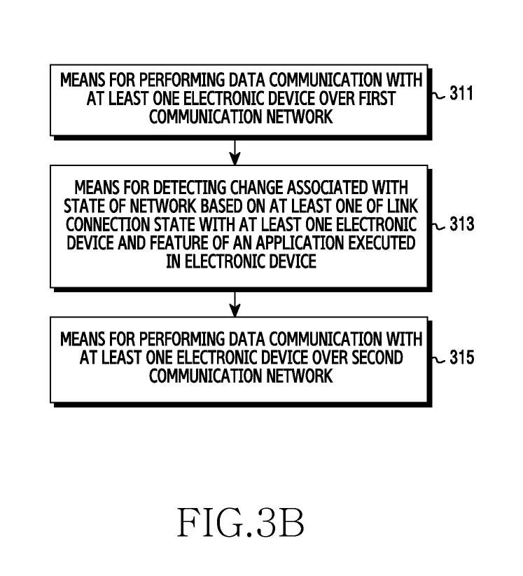

FIG. 3A illustrates a method for, when a network change event is detected, communicating data via the changed network in an electronic device according to an embodiment of the present disclosure.

Referring to FIG. 3A, the electronic device 100 can communicate data with at least one other electronic device over a first short-range wireless communication network in operation 301. In so doing, the first short-range wireless communication network can include one network of Z-wave and WiFi.

Next, the electronic device 100 can detect a change associated with a state of the network based on at least one of a link connection state with at least one other electronic device and a feature of an application executed in the electronic device in operation 303. For example, the electronic device 100 can identify a type of the application based on information of the executed application, and detect the network change event based on the identified application type. For example, the electronic device 100 can calculate a network change probability based on a length of a packet to transmit currently, the number of transmitted packets, the number of packets receiving ACK among the transmitted packets, and the number of nodes currently enabling WiFi, and detect the network change event based on the calculated probability. For example, when detecting link disconnection of the communicating network, the electronic device 100 can detect a network change event.

Next, when detecting the change, the electronic device 100 can communicate data with at least one electronic device over a second short-range wireless communication network in operation 305. More specifically, when detecting the network change event, the electronic device 100 can communicate data over the second short-range wireless communication network which is different from the first short-range wireless communication network. For example, during data communication over the Z-wave network, when detecting a network change event, the electronic device 100 can communicate data over the WiFi network. For example, during data communication over the WiFi network, when detecting a network change event, the electronic device 100 can communicate data over the Z-wave network.

Next, the electronic device 100 can finish the process according to an embodiment of the present disclosure.

FIG. 3B illustrates means for, when a network change event is detected, communicating data via the changed network in an electronic device according to an embodiment of the present disclosure.

Referring to FIG. 3B, the electronic device 100 can include a mean 311 for performing data communication with at least one other electronic device over a first short-range wireless communication network. In so doing, the electronic device 100 can include a communication module for supporting two or more short-range wireless communication networks including Z-wave and WiFi.

Further, the electronic device 100 can include a means 313 for detecting a change associated with a state of the network based on at least one of a link connection state with at least one other electronic device and a feature of an application executed in the electronic device. In so doing, the electronic device 100 can include a means for determining whether the network is changed by identifying a type of the application based on the application feature, a means for determining whether the network is changed based on a link connection state of the communicating short-range wireless communication network, and a means for detecting link disconnection of the communicating network.

Further, the electronic device 100 can include a means 315 for, when detecting the change, performing data communication with at least one electronic device over a second short-range wireless communication network. When the short-range wireless communication network is changed, the electronic device 100 can include a means for indicating corresponding information.

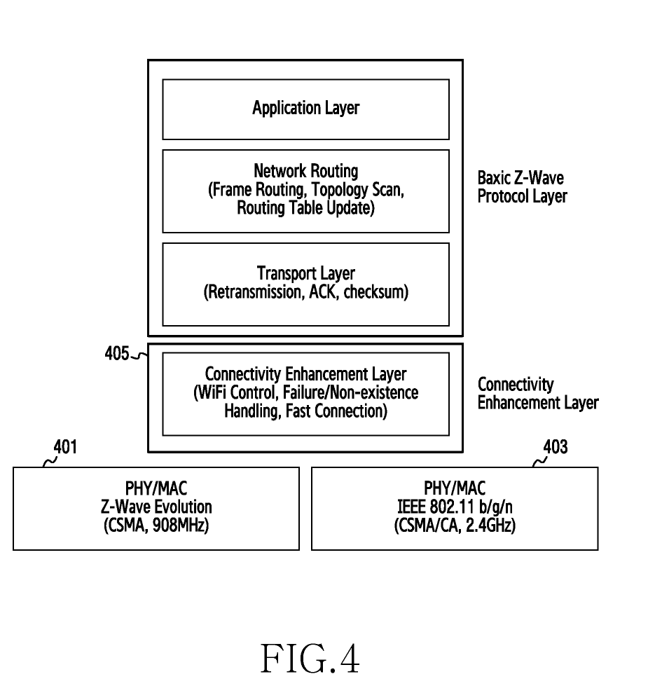

FIG. 4 depicts a protocol stack for selectively using Z-wave and WiFi networks according to an embodiment of the present disclosure.

Referring to FIG. 4, the protocol for selectively using Z-wave and WiFi networks can be configured by constructing a new layer ‘Connectivity Enhancement Layer’ 405 on Media Access Control (MAC) layers 401 and 403 of Z-wave and WiFi.

In so doing, the ‘Connectivity Enhancement Layer’ 405 can control to selectively utilize Z-wave and WiFi networks based on information of Application Layer, Transport Layer, and Network Layer. For example, the ‘Connectivity Enhancement Layer’ 405 can perform the functions of the network selection unit 101 as described in FIG. 1.

Further, when link disconnection is detected, the ‘Connectivity Enhancement Layer’ 405 can control to communicate data using a link of other network without the aid of the higher layer (Application Layer, Transport Layer, and Network Layer). For example, during data communication over the Z-wave network, when link disconnection is detected, the ‘Connectivity Enhancement Layer’ 405 can control to communicate data using a link of the WiFi network without the aid of the higher layer (Application Layer, Transport Layer, and Network Layer). For example, during data communication over the WiFi network, when link disconnection is detected, the ‘Connectivity Enhancement Layer’ 405 can control to communicate data using a link of the Z-wave network without the aid of the higher layer (Application Layer, Transport Layer, and Network Layer).

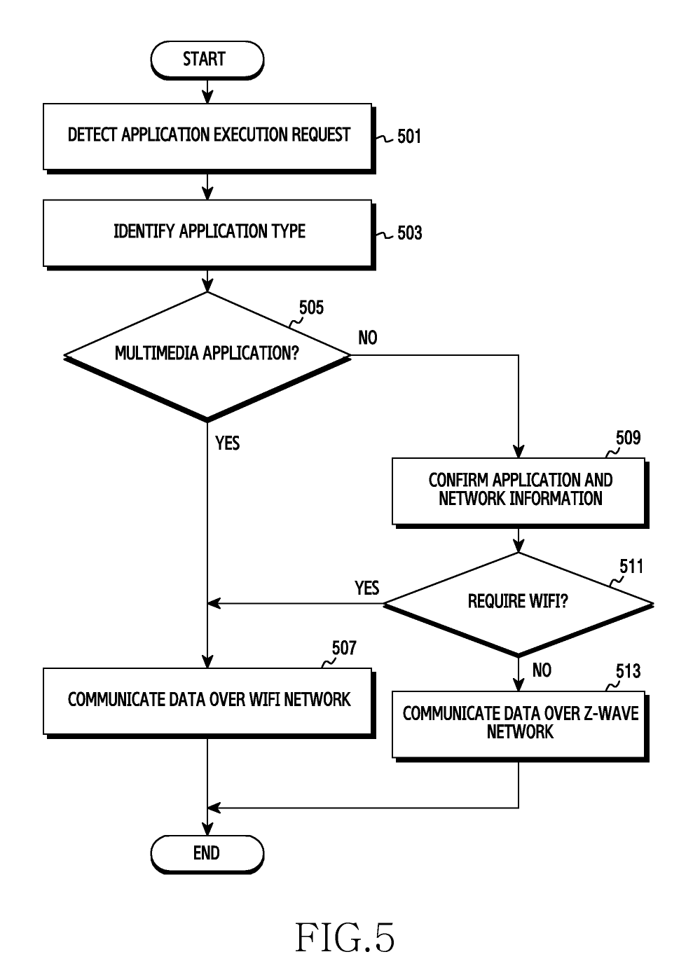

FIG. 5 illustrates a method for selectively using a network according to an application type in an electronic device according to an embodiment of the present disclosure.

Referring to FIG. 5, the electronic device 100 can detect an application execution request in operation 501. For example, the electronic device 100 can detect an execution request of an application requiring a short-range wireless communication network.

Next, the electronic device 100 can identify an application type in operation 503. That is, the electronic device 100 can confirm features of the application of the detected execution request and identify the application type based on the confirmed features. For example, the electronic device 100 can identify the type of the executed application based on a predefined ‘Application Command Class’ value of the communicating network. For example, the network selection unit 101 can determine based on the predefined ‘Application Command Class’ value of the Z-wave network, which one of the control application, the reporting application, and the multimedia application is the executed application.

In operation 505, the electronic device 100 can determine whether the identified application is a multimedia application.

When the identified application is a multimedia application, the electronic device 100 can communicate data over the WiFi network in operation 507. More specifically, when the application of the detected execution request is a multimedia application requiring a higher bandwidth than a threshold bandwidth, the electronic device 100 can transmit and receive data over the WiFi network.

Next, the electronic device 100 can finish the process according to an embodiment of the present disclosure.

By contrast, when the identified application is not a multimedia application in operation 505, the electronic device 100 can confirm application and network information in operation 509. In more detail, when the application of the detected execution request is a control application and a reporting application requiring a lower bandwidth than the threshold bandwidth, the electronic device 100 can confirm application and network information.

Next, the electronic device 100 can determine whether the WiFi network is required in operation 511. In more detail, the electronic device 100 can calculate a network change probability based on a length of a packet to transmit, the number of transmitted packets, the number of packets receiving ACK among the transmitted packets, and the number of nodes currently enabling WiFi, and the electronic device 100 can determine whether to use the WiFi according to the calculation result. For example, the electronic device 100 can calculate a network decision value of the application as expressed in Equation 1, compare the calculated network decision value with a threshold, and thus determine whether to use Z-wave or WiFi for the corresponding application.

$$\begin{matrix}{w}_{—} sum ← {w}_{1} * {d}_{—} len + {w}_{2} * {q}_{—} len + {w}_{3} * {sent}_{—} cnt + {w}_{4} * {acked}_{—} cnt + {w}_{5} * {wifi}_{—} cnt & [ Equation 1 ] \\ {decision}_{—} p ← min \{ \frac{\vert {w}_{—} sum \vert}{\vert {ave}_{—} {w}_{—} sum - {w}_{—} wum \vert} , 1 \} & ( 1 )\end{matrix}$$

Here, w₁ through w₅ denote preset weights, d_len denotes a transmit packet length, q_len denotes the number of queued packets, sent_cnt denotes the number of transmitted packets, acked_cnt denotes the number of packets receiving ACK among the transmitted packets, and wifi_cnt denotes the number of nodes currently enabling WiFi. Also, decision_p denotes a network decision value for the corresponding application, and ave_w_sum is an average value of w_sum and can be continually updated using a preset weight. For example, when the network decision value is greater than a threshold, the electronic device 100 can determine to use WiFi. When the network decision value is smaller than or equal to the threshold, the electronic device 100 can determine to use Z-wave, rather than WiFi.

When the WiFi network is required, the electronic device 100 can communicate data over the WiFi network in operation 507. In so doing, when the electronic device 100 is communicating over the Z-wave network, the electronic device 100 can control a node for communicating to turn on WiFi over the Z-wave network. Next, the electronic device 100 can communicate data with the node which turns on WiFi over the WiFi network.

Next, the electronic device 100 can finish the process according to an embodiment of the present disclosure.

By contrast, when not requiring the WiFi network in operation 511, the electronic device 100 can communicate data over the Z-wave network in operation 513.

Next, the electronic device 100 can finish the process according to an embodiment of the present disclosure.

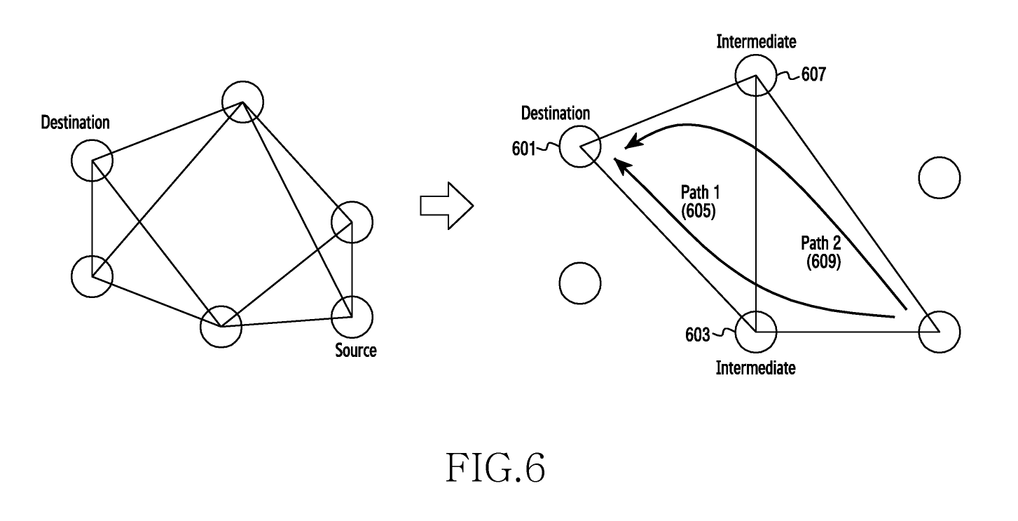

FIG. 6 illustrates communication paths of a WiFi network using a Z-wave network structure in an electronic device according to an embodiment of the present disclosure. The communication paths shown in FIG. 6 correspond to the operation 507 shown in FIG. 5.

Referring to FIG. 6, when the WiFi network is required, the electronic device 100 can discover an intermediate node enabling the WiFi network using ‘Network Connection Graph’ set in the Z-wave network, control to turn on the discovered intermediate node, and then communicate data with a destination node based on the WiFi network via the corresponding intermediate node. When a first path 605 disables the communication to a destination 601 via a first intermediate node 603, the electronic device 100 can perform the communication using a preset second path 609 so as to communicate with the destination 601 via a second intermediate node 607.

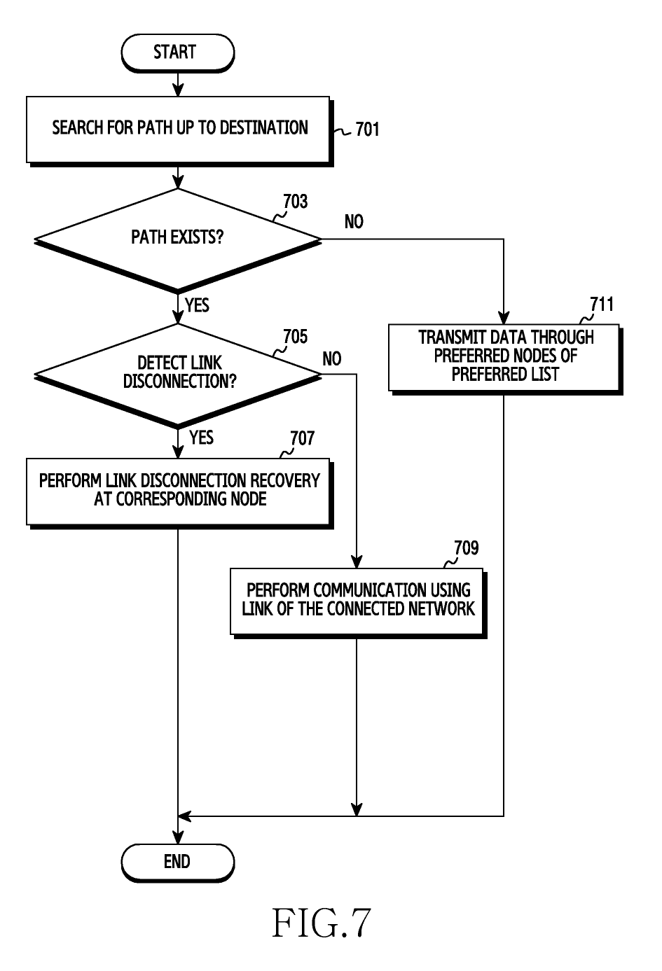

FIG. 7 illustrates a method for communicating data according to presence or absence of a path up to a destination in an electronic device according to an embodiment of the present disclosure.

Referring to FIG. 7, the electronic device 100 can search for a path up to a destination in operation 701. That is, the electronic device 100 can search for a data transmission path to transmit and receive data to the destination.

Next, the electronic device 100 can determine whether the path exists in operation 703. That is, the electronic device 100 can determine whether there is a preset path up to a destination node which data is transmitted and received to and from.

When the path exists, the electronic device 100 can determine whether link disconnection is detected in operation 705.

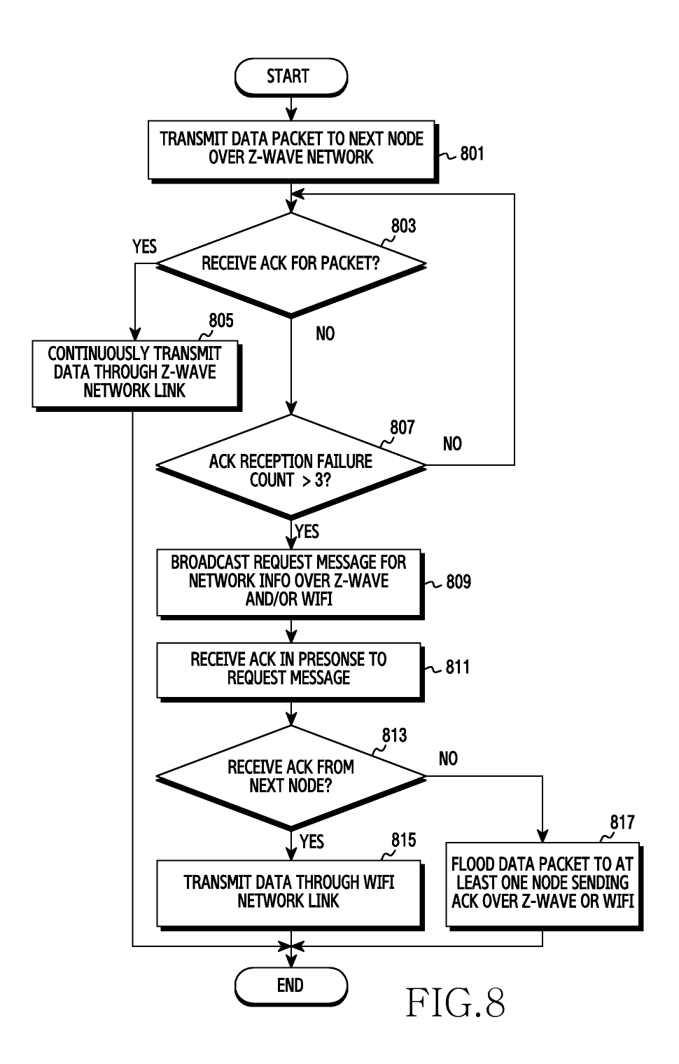

When detecting the link disconnection, the electronic device 100 can perform link disconnection recovery at a corresponding node in operation 707. The link disconnection recovery shall be explained in detail by referring to FIG. 8.

Next, the electronic device 100 can finish the process according to an embodiment of the present disclosure.

By contrast, when not detecting the link disconnection, the electronic device 100 can perform communication using a link of a currently connected network in operation 709. For example, when discovering a path as a result of the path search up to the destination during the communication via the Z-wave network and not detecting link disconnection on the corresponding path, the electronic device 100 can perform the communication using a link of the Z-wave network. For example, when discovering a path as a result of the path search up to the destination during the communication via the WiFi network and not detecting link disconnection on the corresponding path, the electronic device 100 can perform the communication using a link of the WiFi network.

Next, the electronic device 100 can finish the process according to an embodiment of the present disclosure.

When discovering no path in operation 703, the electronic device 100 can transmit data through preferred nodes of a preferred list in operation 711. For example, when there is no path up to the destination, the electronic device 100 can send data to at least one preferred node of the preferred list and request the corresponding preferred nodes to send the data by conducting the link disconnection recovery up to the destination. The link disconnection recovery shall be explained in detail by referring to FIG. 8.

Next, the electronic device 100 can finish the process according to an embodiment of the present disclosure.

FIG. 8 illustrates a method for recovering link disconnection when the link disconnection is detected in an electronic device according to an embodiment of the present disclosure.

Referring to FIG. 8, the electronic device 100 can transmit a data packet to a next node over a Z-wave network in operation 801. At this time, the next node can be an intermediate node between the electronic device 100 and a destination node or the destination node. Also, the electronic device 100 can be a source node of the data packet, or an intermediate node which receives the data packet from the source node

Next, the electronic device 100 can determine whether an ACK of the packet is received in operation 803. That is, the electronic device 100 can send the data packet to the next node, and determine whether an ACK message is received from the corresponding node in response to the data packet.

When receiving the ACK of the packet, the electronic device 100 can continuously transmit data through the link of the Z-wave network in operation 805.

Next, the electronic device 100 can finish the process according to an embodiment of the present disclosure.

By contrast, when not receiving the ACK of the packet, the electronic device 100 can determine whether an ACK reception failure count is greater than three in operation 807.

When the ACK reception failure count is smaller than three, the electronic device 100 can return to operation 803 and re-perform the subsequent operation.

When the ACK reception failure count is greater than three, the electronic device 100 can broadcast a Network info Request message over the Z-wave and/or WiFi networks in operation 809. The Network info Request message is a message for requesting network information which is associated with the Z-wave and/or the WiFi. For example, when data packet transmission over the Z-wave network fails three times, the electronic device 100 can determine link disconnection up to a next node over the Z-wave network, and broadcast the Network info Request message to neighboring nodes including the next node over the WiFi network. For example, when data packet transmission over the Z-wave network fails three times, the electronic device 100 can determine link disconnection up to a next node over the Z-wave network and broadcast the Network info Request message to neighboring nodes including the next node over the Z-wave network. For example, when data packet transmission over the Z-wave network fails three times, the electronic device 100 can determine link disconnection up to a next node over the Z-wave network and broadcast the Network info Request message to neighboring nodes including the next node over the Z-wave and WiFi networks.

Next, the electronic device 100 can receive an ACK of the Network info Request message in operation 811. That is, the electronic device 100 can receive a message including network information in response to the Network info Request message.

Next, the electronic device 100 can determine whether an ACK is received from the next node in operation 813. That is, the electronic device 100 can determine whether the received ACK is an ACK received from the next node.

When receiving the ACK from the next node, the electronic device 100 can transmit data through the link of the WiFi network in operation 815. More specifically, when the ACK is received from the next node, the corresponding ACK is a signal received over the WiFi network and accordingly the electronic device 100 can transmit data through the WiFi network link.

Next, the electronic device 100 can finish the process according to an embodiment of the present disclosure.

By contrast, when not receiving the ACK from the next node, the electronic device 100 can flood a data packet to at least one node sending the ACK over the Z-wave or WiFi network in operation 817. That is, when the received ACK is an ACK received from other node than the next node, the electronic device 100 can control to send the data packet to a destination node via the node from which the ACK is received. For example, when receiving an ACK from other node over the WiFi network, the electronic device 100 can send a data packet to the other node over the WiFi network and thus control to send the corresponding data packet from the other node to the destination node. For example, when receiving an ACK from other node over the Z-wave network, the electronic device 100 can send a data packet to the other node over the Z-wave network and thus control to send the data packet from the other node to the destination node.

Next, the electronic device 100 can finish the process according to an embodiment of the present disclosure.

The exemplary embodiments and all of the functional operations of the present disclosure described herein can be implemented in computer software, firmware, hardware, or in combinations of one or more of them including the structures disclosed in this specification and their structural equivalents. Also, the exemplary embodiments of the present disclosure can be implemented as one or more computer program products, that is, one or more data processors, or one or more modules of computer program instructions encoded on a computer-readable medium to control this device.

The computer-readable medium can be a machine-readable storage medium, a machine-readable storage substrate, a memory device, a material affecting a machine-readable propagated stream, or a combination of one or more of these. The term ‘data processing device’ encompasses every device, apparatus, and machine including, for example, a programmable processor, a computer, multiple processors, or a computer, for processing data. The device can be added to the hardware and include code for creating an execution environment of a corresponding computer program, for example, code for constituting processor firmware, a protocol stack, a database management system, an operating system, or a combination of one or more of these.

In the detailed description of the invention, embodiments has been described specifically, and various changes and modifications of the embodiments described herein can be made without departing from the scope of the invention. Therefore, the scope of the invention should not be limited as the embodiments described herein, and should be defined by the following claims and their equivalents.

1. A method of an electronic device for adaptively changing a network in a wireless communication system, the method comprising:
performing data communication with at least one electronic device over a first communication network;
detecting a change associated with a state of the network based on at least one of a link connection state with the at least one electronic device and a feature of an application executed in the electronic device; and
performing data communication with the at least one electronic device over a second communication network.

2. The method of claim 1, wherein the detecting of the change comprises:
determining whether the network needs to change based on a required bandwidth of the application.

3. The method of claim 2, wherein the determining of whether the network needs to change comprises:
if the required bandwidth of the application is greater than or equal to a threshold bandwidth, determining to change from the first communication network to the second communication network.

4. The method of claim 1, wherein the detecting of the change comprises:
detecting whether a change of the network is required for the application, based on information associated with at least one of transmit/receive packet and a number of nodes enabling the second communication network,
wherein the information associated with the transmit/receive packet comprises at least one of a length of a packet to transmit, a number of packets to be transmitted, a number of transmitted packets, and a number of packets receiving an Acknowledgement (ACK) among the transmitted packets.

5. The method of claim 1, wherein the performing of the data communication with the at least one electronic device over the second communication network comprises:
determining at least one node for performing the data communication over the second communication network;
setting a data transmission/reception path of the electronic device and the at least one node by using a network connection structure obtained when the first wireless communication network is established; and
performing the data communication with the at least one electronic device through the set data transmission/reception path over the second communication network.

6. The method of claim 1, wherein the detecting of the change comprises:
determining whether a link associated with the first communication network is disconnected, based on whether the data communication with the at least one electronic device over the first communication network is successful; and
if determining that the link associated with the first communication network is disconnected, determining that a change of network is required.

7. The method of claim 6, wherein performing the data communication with the at least one electronic device over the second communication network comprises:
after determining that the link associated with the first communication network is disconnected, broadcasting a request message for network information over at least one of the first communication network and the second wireless communication network;
detecting whether a response message in response to the request message is received from the at least one electronic device, over the second communication network; and
if receiving the response message from the at least one electronic device over the second communication network, performing the data communication with the at least one electronic device over the second communication network.

8. The method of claim 7, further comprising:
if not receiving the response message from the at least one electronic device, performing data communication with at least one other electronic device which sends a network response message over at least one of the first communication network and the second communication network.

9. The method of claim 1, wherein the performing of the data communication with the at least one electronic device over the second communication network comprises:
transmitting a message for requesting the at least one electronic device to drive a module for the second communication network.

10. The method of claim 1,
wherein the first communication network is Z-wave, and
wherein the second communication network is Wireless Fidelity (WiFi).

11. An electronic device for adaptively changing a network in wireless communication system, the electronic device comprising:
a network selection unit configured to detect a change associated with a state of the network based on at least one of a link connection state with at least one electronic device and a feature of an application executed in the electronic device; and
a communication unit configured to:
perform data communication with the at least one electronic device over a first communication network; and
when detecting the change, perform data communication with the at least one electronic device over a second communication network.

12. The electronic device of claim 11,
wherein the network selection unit, in order to detect the change, configured to determines whether the network needs to change based on a required bandwidth of the application.

13. The electronic device of claim 12,
wherein, if the required bandwidth of the application is greater than or equal to a threshold bandwidth, the network selection unit, in order to determine whether the network needs to change, configured to determines to change from the first communication network to the second communication network.

14. The electronic device of claim 11,
wherein the network selection unit, in order to detect the change, is configured to detect whether a change of the network is required for the application, based on at least one of information associated with transmit/receive and a number of nodes enabling the second communication network, and
wherein the information associated with the transmit/receive packet comprises at least one of a length of a packet to transmit, a number of packets to be transmitted, a number of transmitted packets, and the a number of packets receiving an Acknowledgement (ACK) among the transmitted packets.

15. The electronic device of claim 11, wherein the network selection unit, in order to perform the data communication over the second communication network, is configured to:
determine at least one node for performing the data communication over the second communication network; and
set a data transmission/reception path of the electronic device and the at least one node by using a network connection structure obtained when the first communication network is established, and
wherein the communication unit is configured to perform the data communication with the at least one electronic device through the set data transmit/receive path over the second communication network.

16. The electronic device of claim 11, wherein the network selection unit is configured to:
determine whether a link associated with the first communication network is disconnected, based on whether the data communication with the at least one electronic device over the first communication network is successful; and
if determining that the link associated with the first communication network is disconnected, determining that a change of the network is required.

17. The electronic device of claim 16, wherein the communication unit is configured to:
after determining the link associated with the first communication network is disconnected, broadcast a request message for network information over at least one of the first communication network and the second communication network;
detect whether a response message in response to the request message is received from the at least one electronic device over the second communication network; and
if receiving the network response message from the at least one electronic device over the second communication network, perform the data communication with the at least one electronic device over the second communication network.

18. The electronic device of claim 17, wherein, if not receiving the response message from the at least one electronic device, the communication unit is further configured to perform data communication with at least one other electronic device which sends a network response message over at least one of the first communication network and the second communication network.

19. The electronic device of claim 11, wherein the network selection unit is configured to transmit a message for requesting the at least one electronic device to drive a module for the second communication network.

20. The electronic device of claim 11,
wherein the first communication network is Z-wave, and
wherein the second communication network is Wireless Fidelity (WiFi).
